(19) United States
(12) Patent Application Publication
(10) Pub. No.: US 2009/0080080 A1
(43) Pub. Date: Mar. 26, 2009

(54) Antiglare Film and Coating Liquid for Forming Antiglare Layer

(75) Inventors: Kae Takahashi, Tokyo (JP); Hisamitsu Kameshima, Tokyo (JP); Tomo Yoshinari, Tokyo (JP); Yusuke Tochigi, Tokyo (JP); Takahiro Morinaga, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/124,957

(22) Filed: May 21, 2008

(30) Foreign Application Priority Data
Sep. 20, 2007 (JP) 2007-243681

(51) Int. Cl. G02B 1/10; G02B 27/00

(52) U.S. Cl. 359/601

(57) ABSTRACT

An antiglare film in which an antiglare layer containing particles and a binder matrix obtained by curing a material curable with ionizing radiation is directly provided on a triacetyl cellulose film. The antiglare layer is formed by a process of directly coating a coating liquid for forming an antiglare layer that contains at least the particles, the material curable with ionizing radiation, and a solvent on the triacetyl cellulose film and forming a coating film on the triacetyl cellulose film, a process of drying the coating film, and a process of curing the coating film by ionizing radiation. A haze difference (Hz(T)−Hz(P)) between a haze value (Hz(T)) of the antiglare layer formed on the triacetyl cellulose film and a haze value (Hz(P)) of an antiglare layer directly formed on a polyethylene terephthalate film by using the coating liquid for forming an antiglare layer under the same conditions as the antiglare layer formed on the triacetyl cellulose film is 1.3% or more to 3.2% or less.

### CROSS REFERENCE TO RELATED APPLICATION

This application is based on and claims the benefit of priority from the Japanese Patent Application number 2007-243681, filed on Sep. 20, 2007; the entire contents of which are incorporated herein by reference.

### BACKGROUND OF THE INVENTION

1. Field of the Invention

The present invention relates to an antiglare film to be provided on the surface of windows, displays, and the like. In particular, the present invention relates to an antiglare film to be provided on the surface displays such as liquid crystal displays (LCD), CRT displays, organic electroluminescence displays (ELD), plasma displays (PDP), surface electric field displays (SED), and field emission displays (FED).

2. Description of the Related Art

From the standpoint of visibility, the following problems are associated with displays such as liquid crystal displays, CRT displays, EL displays, and plasma displays.

Reflection of external light when the display is viewed.

Glitter (scintillation) occurs on the display surface due to the display light from the display.

Deterioration of visibility under the effect of glare of the display light that comes directly, without diffusion, from the display.

Deterioration of visibility caused by defects such as uneven brightness.

Providing an antiglare film on the front surface of a display is known as means for resolving the problems of such visibility decrease and deterioration.

For example, the following methods for producing antiglare films are known.

A method by which a concavity-convexity structure is formed on the antiglare film surface by an emboss processing method.

A method by which a coating liquid in which particles are admixed to a material forming a binder matrix is coated and the particles are dispersed in the binder matrix, thereby forming a concavity-convexity structure on the antiglare film surface.

In an antiglare film in which a concavity-convexity structure formed in the above-described manner is provided on the surface, the external light falling on the antiglare film is scattered by the surface of the concavity-convexity structure, the external light image becomes blurred, and the decrease in visibility caused by the reflection of the external light on the display surface can be prevented.

In an antiglare film in which concavities and convexities are formed on the surface by emboss processing, the surface concavities and convexities can be completely controlled. As a result, reproducibility is good. However, the problem is that where a defect or adhered foreign matter is present on the emboss roll, the defect is transferred with a delay of a roll pitch.

On the other hand, an antiglare film using a binder matrix and particles can be prepared by fewer operations than the above-described antiglare film using emboss processing. Therefore, the film can be manufactured at a low cost. Accordingly, antiglare films of various forms in which particles are dispersed in a binder matrix are known (JP-A-6-18706).

For example, the following methods for producing antiglare films using a binder matrix and particles have been disclosed.

A method using a binder matrix resin, spherical particles, and particles of irregular shape (JP-A-2003-260748).

A method using a binder matrix resin and particles of a plurality of different diameters (JP-A-2004-004777).

A method by which surface concavities and convexities are provided and the surface area of concavities is regulated (JP-A-2003-004903).

For example, the following method is known for forming an antiglare layer on a transparent base material by using a binder matrix and particles.

A method by which an antiglare film is formed from a solution containing a solution of at least one kind that dissolves a triacetyl cellulose film that is a transparent base material and a solvent of at least one kind that does not dissolve the triacetyl cellulose film, such method increasing the adhesive strength between the antiglare layer and the triacetyl cellulose film that is a transparent base material (JP-A-2002-169001).

In an antiglare film provided with a concavity-convexity structure on the surface, the concavity-convexity structure is required to have in-plane uniformity. Where the concavity-convexity structure has no in-plane uniformity, this feature is recognized as unevenness. In particular, in an antiglare film provided on a display surface, because the users observe a display screen over a long period from various directions, it is required that no unevenness be present on the antiglare film surface and that the concavity-convexity structure of the surface have a high degree of in-plane uniformity. It is an object of the present invention to provide an antiglare film having no in-plane unevenness.

### SUMMARY OF THE INVENTION

One gist of the present invention resides in an antiglare film in which an antiglare layer comprising particles and a binder matrix obtained by curing a material curable with ionizing radiation is directly provided on a triacetyl cellulose film, wherein

the antiglare layer is formed by a process of directly coating a coating liquid for forming an antiglare layer that comprises at least the particles, the material curable with ionizing radiation, and a solvent on the triacetyl cellulose film and forming a coating film on the triacetyl cellulose film, a process of drying the coating film, and a process of curing the coating film by ionizing radiation; and

a haze difference (Hz(T)−Hz(P)) between a haze value (Hz(T)) of the antiglare layer formed on the triacetyl cellulose film and a haze value (Hz(P)) of an antiglare layer directly formed on a polyethylene terephthalate film by using the coating liquid for forming an antiglare layer under the same conditions as the antiglare layer formed on the triacetyl cellulose film is 1.3% or more to 3.2% or less.

Another gist of the present invention resides in a transmission liquid crystal display in which the antiglare film in accordance with the present invention, a polarizing plate, a liquid crystal cell, a polarizing plate, and a backlight unit are provided in the order of description from a viewer side.

Yet another gist of the present invention resides in a coating liquid for forming an antiglare layer comprising at least particles, a material curable with ionizing radiation, and a solvent, wherein a haze difference (Hz(T)−Hz(P)) between a haze value (Hz(T)) of the antiglare layer formed by a process of directly coating the coating liquid for forming an antiglare layer on a triacetyl cellulose film and forming a coating film on the triacetyl cellulose film, a process of drying the coating film, and a process of curing the coating film by ionizing radiation; and a haze value (Hz(P)) of an antiglare layer directly formed on a polyethylene terephthalate film by using the coating liquid for forming an antiglare layer under the same conditions as the antiglare layer formed on the triacetyl cellulose film is 1.3% or more to 3.2% or less.

### BRIEF DESCRIPTION OF THE DRAWINGS

FIG. 1 is a schematic cross-sectional view of the antiglare film in accordance with the present invention.

FIGS. 2A and 2B are explanatory drawings for explaining the mechanism of unevenness occurrence in an antiglare film.

FIG. 3 is a schematic drawing of a die coater coating apparatus in accordance with the present invention.

FIG. 4 is a schematic cross-sectional view of an antiglare film of another embodiment of the present invention.

FIGS. 5A and 5B illustrate a transmission liquid crystal display using the antiglare film in accordance with the present invention.

### DETAILED DESCRIPTION OF THE INVENTION

The antiglare film in accordance with the present invention will be described below.

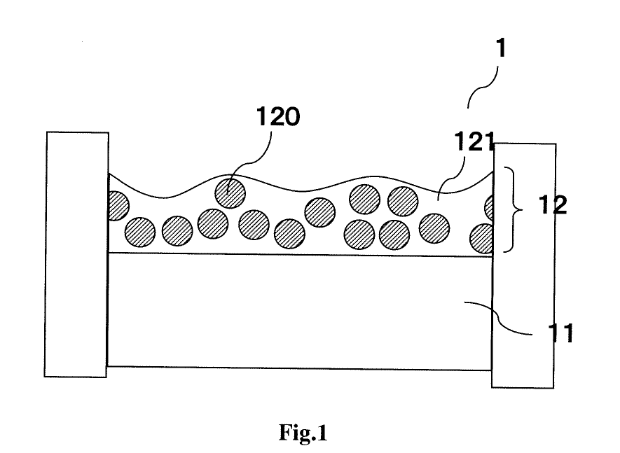

FIG. 1 is a schematic cross-sectional view of the antiglare film in accordance with the present invention. In the antiglare film (1) in accordance with the present invention, an antiglare layer (12) is provided directly on a triacetyl cellulose film (11). The antiglare layer (12) of the antiglare film (1) in accordance with the present invention contains a binder matrix (121) obtained by curing a material curable by ionizing radiation and particles (120). In accordance with the present invention, providing the antiglare layer directly on the triacetyl cellulose film means that the antiglare layer is provided without other interlayers on the triacetyl cellulose film.

In accordance with the present invention, a triacetyl cellulose film is used as a transparent base material. Triacetyl cellulose films have a small birefringence index and good transparency. Therefore, they can be advantageously used when the antiglare film is provided on the display surface, in particular liquid crystal display surface.

In the antiglare film in accordance with the present invention, a concavity-convexity structure is formed on the surface by particles contained in the antiglare layer. The external light falling on the antiglare film can be scattered by the concavity-convexity structure of the antiglare layer surface, and the image of the reflected external light can be blurred. The thickness (H) of the antiglare layer in the antiglare film in accordance with the present invention is preferably within a range of 2 μm or more to 25 μm or less. Where the average thickness of the antiglare layer is less than 2 μm, a surface hardness sufficient for providing the obtained antiglare film on the display surface sometimes cannot obtained. On the other hand, where the average thickness of the antiglare layer is more than 25 μm, the cost is increased, the degree of curling of the obtained antiglare film is increased, and the antiglare film is sometimes unsuitable for processing required to provide it on the display surface. It is even more preferred that the average thickness of the antiglare layer be 3 μm or more to 12 μm or less.

The antiglare layer in accordance with the present invention is formed by a coating process, in which a coating liquid for forming an antiglare layer that comprises at least particles, a material curable with ionizing radiation, and a solvent is used and coated on a triacetyl cellulose film to form a coating film on the triacetyl cellulose film, a drying process of drying the coating film that is performed to remove the solvent fraction contained in the coating film, and a curing process of curing the coating film from which the solvent fraction has been removed by ionizing radiation and obtaining the antiglare layer.

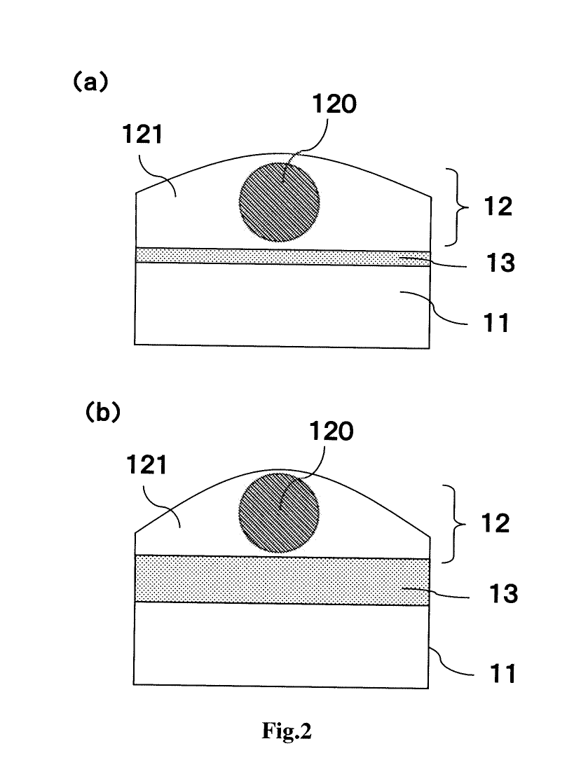

FIG. 2 is an explanatory drawing that illustrates the mechanism of unevenness occurrence in an antiglare film. In FIGS. 2A, 2B, an intermediate layer (13) is formed on the triacetyl cellulose film (11), and an antiglare layer containing the binder matrix (121) and particles (120) is formed on the intermediate layer (13).

Here, the intermediate layer (13) is a layer in which the components of the triacetyl cellulose film (11) and the components of the binder matrix (121) of the antiglare layer are mixed. The intermediate layer is formed by using a solvent that dissolves the triacetyl cellulose film as a solvent of the coating liquid for forming an antiglare layer. Thus, a solution for forming an antiglare layer that contains a solvent that dissolves the triacetyl cellulose film is coated on the triacetyl cellulose film and an antiglare layer is formed, while dissolving the triacetyl cellulose film, whereby an intermediate layer in which the triacetyl cellulose film components and the components of the binder matrix of the antiglare layer are mixed is formed between the triacetyl cellulose film and the antiglare layer. Further, by forming the intermediate layer in which the triacetyl cellulose film components and the components of the binder matrix of the antiglare layer are mixed, it is possible to improve adhesiveness of the antiglare layer and the triacetyl cellulose film.

FIG. 2 illustrates the case (a) in which the thickness of the intermediate layer (13) is small and a case (b) in which the thickness of the intermediate layer (13) is large. In the antiglare film shown in FIG. 2B, the thickness of the intermediate layer is larger than that in the antiglare film shown in FIG. 2A. Where the coated amount of the coating liquid for forming an antiglare layer per unit surface area is taken to be the same in the configurations shown in FIG. 2A and FIG. 2B, the ratio of particles to the binder matrix in the antiglare layer form which the intermediate layer is excluded will be higher in the antiglare layer shown in FIG. 2B than in the antiglare layer shown in FIG. 2A. This is because, part of the material forming the binder matrix is used to form the intermediate layer. Because the ratio of particles in the binder matrix is higher in the antiglare layer shown in FIG. 2B than in the antiglare layer shown in FIG. 2A, the convexity-concavity structure of the antiglare layer surface formed by the particles is larger in the antiglare layer shown in FIG. 2B than in the antiglare layer shown in FIG. 2A.

The intermediate layer shown in FIG. 2 is gradually formed, while the triacetyl cellulose film surface is being dissolved by the solvent dissolving the triacetyl cellulose film that is contained in the coating liquid for forming the antiglare layer. Therefore, there is little space for introducing the particles into the intermediate layer, and accordingly the ratio of particles to the binder matrix in the antiglare layer located on the intermediate layer increases with respect to the ratio of particles to the material for forming the binder matrix in the coating liquid for forming the antiglare layer.

The inventors have discovered that unevenness in the obtained antiglare film occurs due to the mechanism described in sections (1) to (4) below.

(1) The removal speed of the solvent in the coating film composed of the coating liquid for forming an antiglare layer that is present on the triacetyl cellulose film varies over the surface.

(2) Because the removal speed of the solvent in the coating film varies over the surface, a difference in thickness occurs in the intermediate layer formed between the triacetyl cellulose film and the antiglare layer as shown in FIGS. 2A, 2B.

(3) Due to the difference in thickness of the intermediate layer, a difference occurs in the concavity-convexity structure of the surface formed by the particles.

(4) Due to the difference in the concavity-convexity structure on the antiglare layer surface, in-plane unevenness occurs in the antiglare film.

In accordance with the present invention, a coating liquid for forming an antiglare layer in which unevenness easily occurs can be distinguished from a coating liquid for forming an antiglare layer in which unevenness hardly occurs by forming an antiglare layer on a polyethylene terephthalate film under the same forming conditions as the antiglare layer formed on the triacetyl cellulose film and comparing the haze values of the two antiglare layers. As a result, an antiglare film without in-plane unevenness can be obtained.

Polyethylene terephthalate (PET) films have high resistance to solvents and are practically not dissolved in the solvents that are usually used in the coating liquids for forming an antiglare layer. Therefore, such films do not form intermediate layers. In an antiglare layer formed on a triacetyl cellulose film, the ratio of particles in the binder matrix is higher and the concavity-convexity structure present on the surface is larger in size than those in the antiglare layer formed on a polyethylene terephthalate film due to the presence of the intermediate layer. As a result, a high haze value is demonstrated. By selecting a coating liquid for forming an antiglare layer with a small haze difference (Hz(T)−Hz(P)) between a haze value (Hz(T)) of the antiglare layer formed on a triacetyl cellulose film and a haze value (Hz(P)) of the antiglare layer formed on a polyethylene terephthalate film, it is possible to calculate the thickness of the interlayer formed on the interface of the triacetyl cellulose film and the antiglare layer, prevent the formation of excessive intermediate layer, and obtain an antiglare film with no in-plane unevenness.

More specifically, a value (Hz(T)−Hz(P)) obtained by subtracting a haze value (Hz(P)) of the antiglare layer of the antiglare film directly formed on a polyethylene terephthalate film from a haze value (Hz(T)) of the antiglare layer of the antiglare film in which the antiglare layer is directly formed on the triacetyl cellulose film is within a range of 1.3% or more to 3.2% or less.

Where Hz(T)−Hz(P) is more than 3.2%, the capability of the coating liquid for forming an antiglare layer to dissolve the triacetyl cellulose film is high and the thickness of the intermediate layer in the antiglare film for which the triacetyl cellulose film serves as a transparent base material becomes too large, thereby causing in-plane unevenness on the antiglare film surface. On the other hand, where Hz(T)−Hz(P) is less than 1.3%, the capability of the coating liquid for forming an antiglare layer to dissolve the triacetyl cellulose film is low and practically no intermediate layer is formed in the antiglare film for which the triacetyl cellulose film serves as a transparent base material, thereby decreasing the adhesiveness of the antiglare layer and triacetyl cellulose film.

Further, an even more preferred range of the (Hz(T)−Hz(P)) value obtained by subtracting a haze value (Hz(P)) of the antiglare layer of the antiglare film directly formed on a polyethylene terephthalate film from a haze value (Hz(T)) of the antiglare layer of the antiglare film in which the antiglare layer is directly formed on the triacetyl cellulose film is within a range of 1.3% or more to 2.2% or less.

The haze value of the antiglare layer in accordance with the present invention is obtained by subtracting a haze value of the triacetyl cellulose film or polyethylene terephthalate film unit that is a transparent base material from a haze value of the antiglare film in which the antiglare layer is formed on the triacetyl cellulose film or polyethylene terephthalate film unit that is a transparent base material. These haze values are measured using a haze meter according to JIS-K7105.

In the preferred range of a mean particle size of the particles used in the antiglare film in accordance with the present invention, the mean particle size is equal to or more than a value obtained by multiplying the average film thickness of the antiglare layer by 0.1 and equal to or less than a value obtained by multiplying the average film thickness of the antiglare layer by 1.7. Where the mean particle size of the particles is equal to or less than a value obtained by multiplying the average film thickness of the antiglare layer by 0.1, the unevenness caused by changes in the concavity-convexity structure of the antiglare layer surface that is formed by the particles due to the fluctuations of the intermediate layer thickness tends to become unnoticeable. On the other hand, where the mean particle size of the particles is more than a value obtained by multiplying the average film thickness of the antiglare layer by 1.7, the particles can easily fall out of the formed antiglare layer surface.

In accordance with the present invention, the average thickness of the antiglare layer is an average thickness of the antiglare layer where surface concavities and convexities are present. The average thickness can be found with an electron micrometer or a fully automatic micro shape measurement device. Further, the mean particle size of the particles used in accordance with the present invention is found with a particle size distribution measurement device of alight scattering type. Where particles of a plurality of kinds that differ in the average diameter are used, it is preferred that the particles of at least one kind have a mean particle size within the aforementioned range.

A method for manufacturing the antiglare film in accordance with the present invention will be described below. The antiglare film in accordance with the present invention is formed by a coating process, in which a coating liquid for forming an antiglare layer that comprises at least particles, a material curable with ionizing radiation, and a solvent is used and coated on a triacetyl cellulose film to form a coating film on the triacetyl cellulose film, a drying process of drying the coating film that is performed to remove the solvent fraction contained in the coating film, and a curing process of curing the coating film from which the solvent fraction has been removed by ionizing radiation and obtaining the antiglare layer.

As mentioned above, the triacetyl cellulose film that is a transparent base material has a low birefringence index and good transparency and, therefore, can be advantageously used when an antiglare film is provided on a display surface, in particular a liquid crystal display surface. A well-known triacetyl cellulose film can be used, and the film thickness is preferably within a range of 25 μm or more to 200 μm or less, and even more preferably within a range of from 40 μm or more to 80 μm or less.

A well-known polyethylene terephthalate film also can be used in accordance with the present invention. The thickness of the polyethylene terephthalate film is preferably of the same order as that of the triacetyl cellulose film.

The coating liquid for forming an antiglare layer that is used in accordance with the present invention will be described below. The coating liquid for forming an antiglare layer in accordance with the present invention comprises at least particles and a material curable by ionizing radiation.

The particles used in accordance with the present invention are appropriately selected from organic particles such as acryl particles (refractive index 1.49), acryl styrene particles (refractive index 1.49 to 1.59), polystyrene particles (refractive index 1.59), polycarbonate particles (refractive index 1.58), melamine particles (refractive index 1.66), epoxy particles (refractive index 1.58), polyurethane particles (refractive index 1.55), Nylon particles (refractive index 1.50), polyethylene particles (refractive index 1.50 to 1.56), polypropylene particles (refractive index 1.49), silicone particles (refractive index 1.43), polytetrafluoroethylene particles (refractive index 1.35), poly(vinylidene fluoride) particles (refractive index 1.42), poly(vinyl chloride) particles (refractive index 1.54), and poly (vinylidene chloride) particles (refractive index 1.62) and inorganic particles such as silica particles (refractive index 1.48), alumina particles (refractive index 1.76), talc particles (refractive index 1.54), various alumino silicates (refractive index 1.50 to 1.60), kaolin clay (refractive index 1.53), and MgAl hydrotalcites (refractive index 1.50). The particles used in accordance with the present invention may be of one kind or of a plurality of kinds.

Examples of materials suitable as the material curable by ionizing radiation used as the material for forming the binder matrix that is contained in the coating liquid for forming an antiglare layer in accordance with the present invention include polyfunctional acrylates such as acrylic acid or methacrylic acid esters of polyhydric alcohols and polyfunctional urethane acrylates such that can be synthesized from diisocyanates, polyhydric alcohols, and acrylic acid or methacrylic acid hydroxyl esters. Further, a polyether resin, a polyester resin, an epoxy resin, an alkyd resin, a spyroacetal resin, a polybutadiene resin, and a polythiolpolyene resin having an acrylate-type functional group can be also used as the material curable by ionizing radiation.

Among them, trifunctional acrylate monomers or tetra functional acrylate monomers are preferably used as the material curable by ionizing radiation. By using a trifunctional acrylate monomer or tetra functional acrylate monomer, it is possible to obtain an antiglare film that has a sufficient scratch resistance. Specific examples of trifunctional acrylate monomers or tetra functional acrylate monomers include those polyfunctional acrylate monomers such as acrylic acid or methacrylic acid esters of polyhydric alcohols, or polyfunctional urethane acrylates, such that can be synthesized from diisocyanates, polyhydric alcohols, and acrylic acid or methacrylic acid hydroxyl esters, that have a functionality of three or four. The total content ratio of trifunctional acrylate monomers or tetra functional acrylate monomers with respect to a material forming a binder matrix is preferably 80 wt.% or more.

The material forming a binder matrix can also contain a thermoplastic resin in addition to the material curable by ionizing radiation. Examples of thermoplastic resins include cellulose derivatives such as acetyl cellulose, nitrocellulose, acetyl butyl cellulose, ethyl cellulose, and methyl cellulose, vinyl resins such as vinyl acetate and copolymers thereof, vinyl chloride and copolymers thereof, and vinylidene chloride and copolymers thereof, acetal resins such as polyvinyl formal and polyvinyl butyral, acryl-based resins such as acrylic resins and copolymers thereof and methacrylic resin and copolymers thereof, polystyrene resins, polyamide resins, linear polyester resins, and polycarbonate resins. By adding a thermoplastic resin, it is possible to suppress curing in the manufactured antiglare film.

A well-known solvent can be used as a solvent employed in the coating liquid for forming an antiglare layer. The solvent has to include at least a solvent that will dissolve a triacetyl cellulose film in order to form an intermediate layer between the triacetyl cellulose and the antiglare layer. It is preferred that the solvent be a mixed solvent containing a combination of a solvent that will dissolve the triacetyl cellulose film and a solvent that will not dissolve the triacetyl cellulose film.

Examples of solvents that will dissolve the triacetyl cellulose film include ethers such as dibutyl ether, dimethoxymethane, dimethoxyethane, diethoxyethane, propylene oxide, dioxane, dioxolan, trioxane, tetrahydrofuran, anisol, and phenetol, some ketones such as acetone, methyl ethyl ketone, diethyl ketone, dipropyl ketone, diisobutyl ketone, cyclopetanone, cyclohexanone, methyl cyclohexanone, and ethyl cyclohexanone, esters such as ethyl formate, propyl formate, n-pentyl formate, methyl acetate, ethyl acetate, methyl propionate, ethyl propionate, n-pentyl acetate, and γ-butyrolactone, and cellosolves such as methyl cellosolve, cellosolve, butyl cellosolve, and cellosolve acetate. These solvents can be used individually or in combinations of two or more thereof.

Examples of solvents that do not dissolve a triacetyl cellulose film include aromatic hydrocarbons such as toluene, xylene, cyclohexane, and cyclohexylbenzene, hydrocarbons such as n-hexane, some esters such as butyl acetate and isobutyl acetate, carbonates, such as dimethyl carbonate, and some ketones such as methyl isobutyl ketone and methyl butyl ketone. These solvents can be used individually or in combinations of two or more thereof.

Where ultraviolet radiation is used as ionizing radiation in the curing process, a photo polymerization initiator can be added to the coating liquid for forming an antiglare layer. A well-known photopolymerization initiator can be used for this purpose, but it is preferred that a photopolymerization initiator contained in the material used for forming a binder matrix be employed. Examples of photopolymerization initiators include benzoin and alkyl ethers thereof such as benzoin, benzoin methyl ether, benzoin ethyl ether, benzoin isopropyl ether, and benzyl methyl ketal. The amount of photopolymerization initiator used is 0.5 wt. % or more to 20 wt. % or less, preferably 1 wt. % or more to 5 wt. % or less, based on the material curable with ionization radiation.

In accordance with the present invention, additive called a surface-adjusting agent may be added to prevent the occurrence of coating film defects such as crossing on the antiglare layer (coating film) that is formed by coating. According to the action thereof, the surface-adjusting agents are called leveling agents, antifoaming agents, interface tension adjusting agents, and surface tension adjusting agents, but all these agents act to decrease the surface tension of the coating film (antiglare layer) formed.

Examples of additives that are usually used as surface-adjusting agents include silicone-based additives, fluorine-containing additives, and acrylic additives. Derivatives containing polydimethylsiloxane as the base structure in which side chains of the polydimethylsiloxane structure are modified are used as the silicone-based additives. For example, a polyether-modified dimethylsiloxane is used as a silicone additive. Compounds comprising perfluoroalkyl groups are used as fluorine-containing additives. Compounds in which a structure obtained by polymerizing an acryl monomer, a methacryl monomer, or a styrene monomer as the base structure are used as the acryl additives. Acryl additives may also have a base structure obtained by polymerizing an acryl monomer, a methacryl monomer, or a styrene monomer and contain a substituent such as an alkyl group, a polyether group, a polyester group, a hydroxyl group, and an epoxy group in a side chain.

Further, in addition to the above-described surface-adjusting agent, the coating liquid for forming an antiglare layer in accordance with the present invention may also contain other additives. These additives are preferably added within ranges in which they produce no adverse effect on the transparency of the antiglare layer formed and diffusion ability of light. Examples of suitable functional additives include antistatic agents, UV absorbers, IR absorbers, antifouling agents, water repellents, refractive index adjusting agents, adhesiveness improving agents, and curing agents. By using these additives, it is possible to impart the antiglare layer formed with functions other than the antiglare function, for example, antistatic function, UV absorption function, IR absorption function, antifouling function, and water repellency.

In the coating process, the coating liquid for forming an antiglare layer is coated on a triacetyl cellulose film and a coating film is formed. Examples of methods suitable for coating the coating liquid for forming an antiglare layer on the triacetyl cellulose film include methods using a roll coater, a reverse roll coater, a gravure coater, a knife coater, a bar coater, and a die coater. Among them, a die coater is preferably used because it allows the coating to be performed at a high rate with a roll-to-roll system. The concentration of solids in the coating liquid differs depending on the coating method. The concentration of solids is preferably within a range of about 30 to 70 wt. %, as represented by a weight ratio.

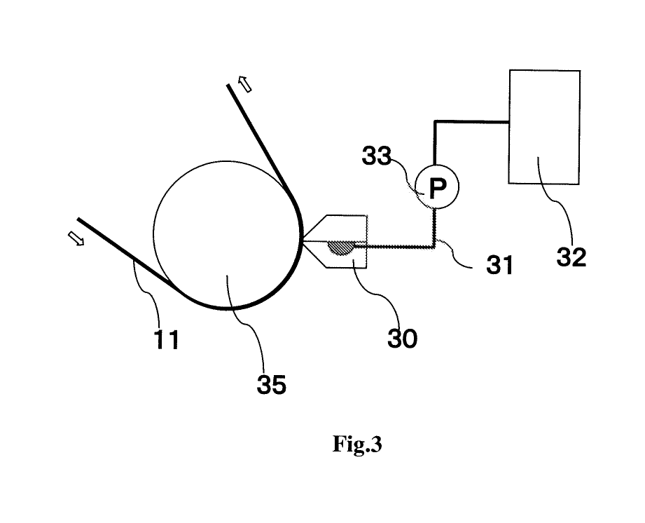

A coating apparatus using a die coater in accordance with the present invention will be described below. FIG. 3 is a schematic drawing illustrating a coating apparatus using a die coater in accordance with the present invention. The coating apparatus using a die coater in accordance with the present invention has a structure in which a die head 30 is connected to a coating liquid tank 32 by a pipe 31, and the coating liquid for forming an antiglare layer contained in the coating liquid tank 32 is pumped into the die head 30 by a liquid pump 33. The coating liquid for forming an antiglare layer pumped into the die head 30 is discharged from a slit gap, and a coating film is formed on a triacetyl cellulose film 11. By using a rolled transparent base material 11 and employing a rotary roll 35, it is possible to form the coating film on the transparent base material continuously by a roll-to-roll system.

After the coating film composed of the coating liquid for forming an antiglare layer has been formed on the triacetyl cellulose film by the coating process, a drying process is performed in which the coating film is dried to remove the solvent fraction contained in the coating film. Heating, air blowing, and hot air blowing can be employed as the drying means. For example, when an antiglare film is manufactured by a roll-to-roll system, the solvent can be removed after the coating has been completed by passing the triacetyl cellulose film provided with the coating film through a drying furnace or oven. Further, it is preferred that the solvent be removed and the coating film be dried to attain a state, in which the coating film can be cured by irradiation with ionizing radiation, within 5 min after the coating liquid for forming an antiglare layer has been coated on the triacetyl cellulose film.

The antiglare layer is formed by irradiating by ionizing radiation the coating film from which the solvent has been removed in the drying process. Ultraviolet radiation and an electron beam can be used as the ionizing radiation. In the case of ultraviolet radiation, a light source such as a high-pressure mercury lamp, a low-pressure mercury lamp, an ultrahigh-pressure mercury lamp, a metal halide lamp, a carbon arc, and a xenon arc can be used. In the case of electron beam curing, electron beams can be used that are emitted from a variety of electron beam accelerators, for example, a Cockroft Walton accelerator, a Van der Graaf accelerator, a resonance-transformer accelerator, an insulating core-transformer accelerator, a linear accelerator, a dynamitron accelerator, and a high-frequency accelerator. The electron beam preferably has an energy of 50 to 1000 KeV. An electron beam having an energy of 100 KeV or more to 300 KeV or less is even more preferred.

The antiglare layer in which an antiglare film is provided on the triacetyl cellulose film in accordance with the present invention is manufactured in the above-described manner. In accordance with the present invention, where an antiglare layer is formed on a polyethylene terephthalate film, the conditions have to be identical to those under which an antiglare layer is formed on a triacetyl cellulose film.

If necessary a functional layer having an antireflection capability, antistatic capability, antifouling capability, electromagnetic shielding capability, UV absorption capability, IR absorption capability, and color correction capability can be provided on the antiglare film in accordance with the present invention. Examples of such functional layers include an antireflection layer, an antistatic layer, a antifouling layer, an electromagnetic shielding layer, an UV absorbing layer, an IR absorbing layer, and a color correcting layer. These functional layers may have a single-layer or multilayer structure. One functional layer may have a plurality of functions. For example, an antireflection layer can have an anti fouling capability. These functional layers can be provided on the antiglare layer. Alternatively, they maybe provided on the surface of the triacetyl cellulose film opposite that on which the antiglare layer has been formed.

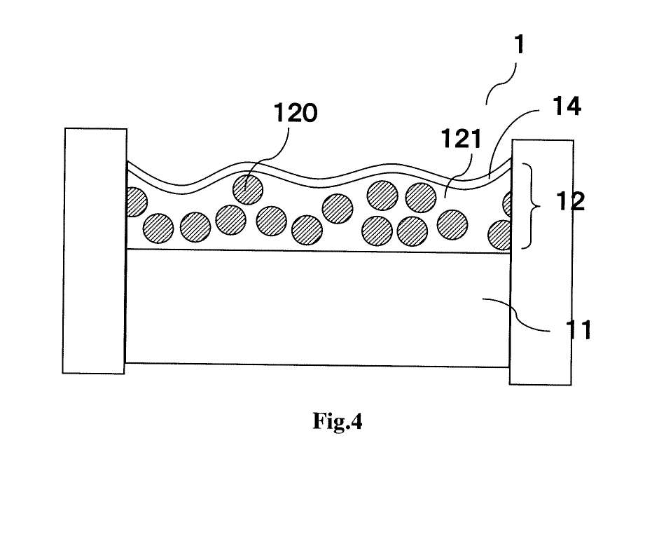

FIG. 4 is a schematic cross-sectional view of an antiglare film of another embodiment of the present invention. In the antiglare film in accordance with the present invention that is shown in FIG. 4, an antiglare film (1) has an antiglare layer (12) on one surface of a transparent base material (11), and an antireflective layer (13) is provided on the antiglare layer (12). In this case, the antireflective layer can be an antireflective layer of a monolayer structure that is formed from a single layer having a low refractive index, or an antireflective layer of a multilayer structure having a repeating configuration of layers with a low refractive index and layers with a high refractive index.

A method for forming the antireflective layer in the antiglare film comprising the antireflective layer as a functional layer on the antiglare layer, such as shown in FIG. 4, will be described below. The antireflective layer can be an antireflective layer of a monolayer structure that is formed from a single layer having a low refractive index, or an antireflective layer of a multilayer structure having a repeating configuration of layers with a low refractive index and layers with a high refractive index. Methods for forming the antireflective layer can be divided into wet film forming methods by which a coating liquid for forming an antireflective layer is coated on the surface of an antiglare layer, and vacuum film forming methods such as a vacuum vapor deposition method, a sputtering method, and a CVD method.

A method for forming an antireflective layer by which a coating liquid for forming an antireflective layer is formed on the surface of an antiglare layer and a monolayer having a low refractive index is formed by a wet film forming method will be described below. The thickness (d) of the monolayer with a low refractive index that is an antireflective layer is so designed that an optical thickness (nd) obtained by multiplying the thickness (d) by the refractive index (n) of the layer having a low refractive index is equal to ¼ of the visible light wavelength. A layer in which particles having a low refractive index are dispersed in a binder matrix can be used as the layer with a low refractive index.

Particles composed of a low-refractive material such as magnesium fluoride, calcium fluoride, or porous silica can be used as the particles having a low refractive index. On the other hand, polyfunctional acrylates such as acrylic acid or methacrylic acid esters of polyhydric alcohols and polyfunctional urethane acrylates such that can be synthesized from diisocyanates, polyhydric alcohols, and acrylic acid or methacrylic acid hydroxyl esters, which are materials curable by ionizing radiation, can be used as the materials for forming a binder matrix. Further, a polyether resin, a polyester resin, an epoxy resin, an alkyd resin, a spyroacetal resin, a polybutadiene resin, and a polythiolpolyene resin having an acrylate-type functional group can be also used as the material curable by ionizing radiation. When such materials curable by ionizing radiation are used, the binder matrix is formed by irradiating with ionizing radiation such as ultraviolet radiation or electron beams. Further, metal alkoxides such as silicon alkoxides, e.g., tetramethoxysilane or tetraethoxysilane can be used as the material for forming a binder matrix. With these materials, an inorganic or organic-inorganic composite binder matrix can be obtained by hydrolysis and dehydration condensation.

Further, the layer having a low refractive index can be obtained not only by dispersing particles having a low refractive index in a binder matrix. Thus, such layer can be formed from a fluorine-containing organic material having a low refractive index, without using the low-refractive particles.

A coating liquid for forming a layer having a low-refractive index that contains the material having a low refractive index and the material for forming a binder matrix is coated on the surface of the antiglare layer. In this case, a solvent and various additives can be added, if necessary, to the coating liquid for forming a layer having a low refractive index. The solvent can be appropriately selected, with consideration for suitability for coating, from aromatic hydrocarbons such as toluene, xylene, cyclohexane, and cyclohexylbenzene, hydrocarbons such as n-hexane, ethers such as dibutyl ether, dimethoxymethane, dimethoxyethane, diethoxyethane, propylene oxide, dioxane, dioxolan, trioxane, tetrahydrofuran, anisol, and phenetol, ketones such as methyl isobutyl ketone, methyl butyl ketone, acetone, methyl ethyl ketone, diethyl ketone, dipropyl ketone, diisobutyl ketone, cyclopentanone, cyclohexanone, methyl cyclohexanone, and methyl cyclohexanone, esters such as ethyl formate, propyl formate, n-pentyl formate, methyl acetate, ethyl acetate, methyl propionate, ethyl propionate, n-pentyl acetate, and γ-butyrolactone, and cellosolves such as methyl cellosolve, cellosolve, butyl cellosolve, and cellosolve acetate, alcohols such as methanol, ethanol, and isopropyl alcohol, and water. Examples of suitable additives include surface adjusting agents, antistatic agents, antifouling agents, water repellent agents, refractive index adjusting agents, adhesiveness improving agents, and curing agents.

Examples of methods suitable for coating include methods using a roll coater, a reverse roll coater, a gravure coater, a knife coater, a bar coater, and a die coater.

Where a material curable with ionizing radiation is used as a material for forming a binder matrix for the coating film obtained by coating the coating liquid on a transparent base material, the layer with a low-refractive index is formed, if necessary, by irradiating with ionizing radiation after the coating film has been dried. Further, when a metal alkoxides is used as a material for forming a binder matrix, a layer with a low refractive index is formed by a heating process such as heating.

When a layer having a low refractive index is formed by a vacuum film forming method, the layer having a low refractive index can be obtained by forming a film of a material having a low refractive index such as magnesium fluoride by a vacuum vapor deposition method. Further, when an antireflective layer with a multilayer structure having a repeating configuration of layers with a low refractive index and layers with a high refractive index is produced, the antireflective layer can be obtained, for example, by forming films of titanium oxide as a layer with a high refractive index, a film of silicon oxide as a layer with a low refractive index, a film of titanium oxide as a layer with a high refractive index, and a film of silicon oxide as a layer with a low refractive index by a vacuum vapor deposition method in the order of description from the side of the antiglare layer.

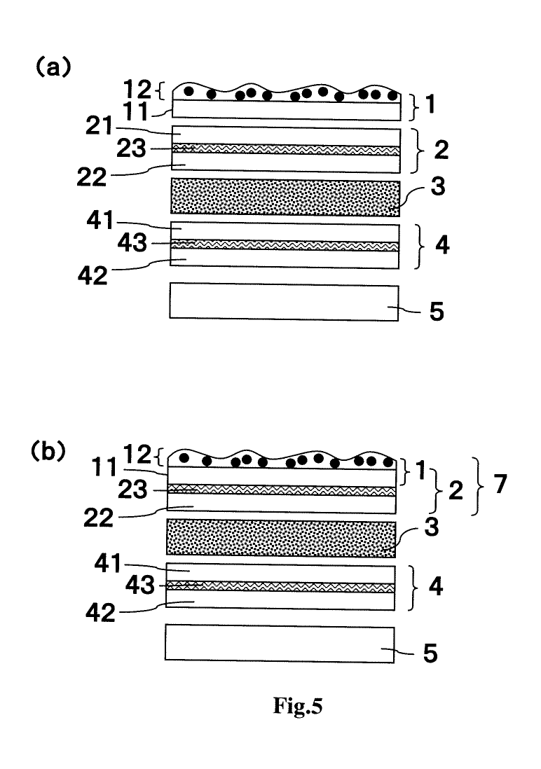

FIG. 5 shows a transmission liquid crystal display using the antiglare film in accordance with the present invention. In the transmission liquid crystal display shown in FIG. 5A, a backlight unit (5), a polarizing plate (4), a liquid crystal cell (3), a polarizing plate (2), and an antiglare film (1) are provided in the order of description. In this case, the side where the antiglare film (1) is provided is the observation side, that is, the display surface.

The backlight unit (5) comprises a light source and a light diffusion plate. The liquid crystal cell has a structure in which electrodes are provided on one transparent base material, electrodes and color filters are provided on the other transparent base material, and liquid crystals are enclosed between the electrodes. The polarizing plates that are installed on both sides of the liquid crystal cell (3) and have a structure in which polarizing layers (23, 43) are sandwiched between transparent base materials (21, 22, 41, 42).

FIG. 5A shows a transmission liquid crystal display in which a transparent base material (11) of the antiglare film (1) and the transparent base material of the polarizing plate (2) are provided separately. On the other hand, in the structure shown in FIG. 5B, a polarizing layer (23) is provided on the surface of the triacetyl cellulose film (transparent base material 11) of the antiglare film (1) opposite that where the antiglare layer is formed, and the triacetyl cellulose film (transparent base material 11) serves as both the transparent base material of the antiglare film (1) and the transparent base material of the polarizing plate (2).

The transmission liquid crystal display in accordance with the present invention may also comprise other functional members. Examples of other functional members include a diffusion film, a prism sheet, a brightness increasing film, and a phase difference film for compensating the phase difference of the liquid crystal cell or polarizing plate, these members serving to use effectively the light emitted by a backlight, but the transmission liquid crystal display in accordance with the present invention is not limited to the listed members.

With the antiglare film of the above-described configuration, it is possible to obtain an antiglare film with no in-plane unevenness.

### EXAMPLES

Examples will be described below.

### Example 1

A coating liquid for forming an antiglare layer that was composed of a material for forming a binder matrix described in Table 1 and also particles A, particles B, and solvent shown in the coating liquid 1 in Table 2 was used. A triacetyl cellulose film (TD-80U, manufactured by Fuji Photo Film Co., Ltd.) was used as a triacetyl cellulose film. A coating film was formed by coating the coating liquid for forming an antiglare layer with a bar coater (#5, manufactured by R. D. S. Webster N.Y.). After the coating process has been completed, the triacetyl cellulose film with the coating film formed thereon was placed in an oven heated within 1 min to 50° C. and dried for 1 min in the oven to remove the solvent contained in the coating film. Upon the removal of solvent, the coating film was cured by irradiation with ultraviolet radiation at 400 mJ/cm² by using a high-pressure mercury lamp under a nitrogen atmosphere, and an antiglare film was produced in which an antiglare layer was provided on the triacetyl cellulose film. A comparison sample was then produced in which a polyethylene terephthalate film (Lumirror, manufactured by Toray Industries, Inc.) was used instead of the triacetyl cellulose film, and an antiglare layer was formed on the polyethylene terephthalate film under same conditions as the antiglare layer was formed on the triacetyl cellulose film.

### Example 2

An antiglare film having an antiglare layer on a triacetyl cellulose film and a comparative sample having an antiglare layer on a polyethylene terephthalate film were produced in the same manner as in Example 1, except that a coating liquid 2 shown in Table 2 was used instead of the coating liquid 1 shown in Table 2 as a coating liquid.

### Example 3

An antiglare film having an antiglare layer on a triacetyl cellulose film and a comparative sample having an antiglare layer on a polyethylene terephthalate film were produced in the same manner as in Example 1, except that a coating liquid 3 shown in Table 2 was used instead of the coating liquid 1 shown in Table 2 as a coating liquid.

### Comparative Example 1

An antiglare film having an antiglare layer on a triacetyl cellulose film and a comparative sample having an antiglare layer on a polyethylene terephthalate film were produced in the same manner as in Example 1, except that a coating liquid 4 shown in Table 2 was used instead of the coating liquid 1 shown in Table 2 as a coating liquid.

### Comparative Example 2

An antiglare film having an antiglare layer on a triacetyl cellulose film and a comparative sample having an antiglare layer on a polyethylene terephthalate film were produced in the same manner as in Example 1, except that a coating liquid 5 shown in Table 2 was used instead of the coating liquid 1 shown in Table 2 as a coating liquid.

### Comparative Example 3

An antiglare film having an antiglare layer on a triacetyl cellulose film and a comparative sample having an antiglare layer on a polyethylene terephthalate film were produced in the same manner as in Example 1, except that a coating liquid 6 shown in Table 2 was used instead of the coating liquid 1 shown in Table 2 as a coating liquid.

### Comparative Example 4

An antiglare film having an antiglare layer on a triacetyl cellulose film and a comparative sample having an antiglare layer on a polyethylene terephthalate film were produced in the same manner as in Example 1, except that a coating liquid 7 shown in Table 2 was used instead of the coating liquid 1 shown in Table 2 as a coating liquid. In comparative Example 4, the antiglare layer was formed by using particles of one kind.

TABLE 1

| | | Parts by |
|---|---|---|
| Material for forming binder matrix | | weight |
| Material curable by | Pentaerythritol triacrylate (manufactured | 94.5 |
| ionizing radiation | by Kyoeisha Chemical Co., Ltd.) | |
| Photopolymerization | Irgacure 184 (manufactured by | 5.0 |
| initiator | Chiba Specialty Chemicals Co., Ltd.) | |
| Leveling agent | Fluorine-containing additive, Megafac | 0.5 |
| | F470 (manufactured by Dainippon Inks | |
| | and Chemicals Co., Ltd.) | |

TABLE 2

| | | | | Parts by |
|---|---|---|---|---|
| | | Particles and solvents | | weight |
| Example 1 | Coating | Particles A | PMMA particles (mean | 15.0 |
| | liquid 1 | | particle size 6.4 μm) | |
| | | Particles B | PMMA particles (mean | 10.0 |
| | | | particle size 2.3 μm) | |
| | | Solvent | Dioxolan | 30.0 |
| | | | Toluene | 70.0 |
| Example 2 | Coating | Particles A | Styrene particles (mean | 10.0 |
| | liquid 2 | | particle size 3.5 μm) | |
| | | Particles B | PMMA particles (mean | 10.0 |
| | | | particle size 3.2 μm) | |
| | | Solvent | Ethyl acetate | 50.0 |
| | | | Butyl acetate | 50.0 |
| Example 3 | Coating | Particles A | Silica particles (mean | 5.0 |
| | liquid 3 | | particle size 2.2 μm) | |
| | | Particles B | Silica particles (mean | 5.0 |
| | | | particle size 2.2 μm) | |
| | | Solvent | Dimethyl carbonate | 34.0 |
| | | | Isobutyl acetate | 66.0 |
| Comparative | Coating | Particles A | PMMA particles (mean | 15.0 |
| Example 1 | liquid 4 | | particle size 6.4 μm) | |
| | | Particles B | PMMA particles (mean | 10.0 |
| | | | particle size 2.3 μm) | |
| | | Solvent | Dioxolan | 33.0 |
| | | | Toluene | 67.0 |
| Comparative | Coating | Particles A | Styrene particles (mean | 10.0 |
| Example 2 | liquid 5 | | particle size 7.8 μm) | |
| | | Particles B | PMMA particles (mean | 10.0 |
| | | | particle size 3.2 μm) | |
| | | Solvent | Dioxolan | 30.0 |
| | | | Butyl acetate | 70.0 |
| Comparative | Coating | Particles A | Acryl styrene particles | 10.0 |
| Example 3 | liquid 6 | | (mean particle size | |
| | | | 5.2 μm) | |
| | | Particles B | PMMA particles (mean | 10.0 |
| | | | particle size 2.8 μm) | |
| | | Solvent | Dimethyl carbonate | 34.0 |
| | | | Butyl acetate | 66.0 |
| Comparative | Coating | Particles | Silica particles (mean | 10.0 |
| Example 4 | liquid 7 | | particle size 2.2 μm) | |
| | | Solvent | Dioxolan | 25.0 |
| | | | Toluene | 75.0 |

HAZE measurements were performed by the following method with respect to the antiglare films and comparative samples obtained in the examples and comparative examples. Further, the evaluation of unevenness of the antiglare layer and the evaluation of adhesiveness between the antiglare layer and the triacetyl cellulose film in the antiglare films obtained in the examples and comparative examples were performed by the below-described methods. The average thickness of the antiglare layer of the antiglare films obtained in the examples and comparative examples is shown in Table 3.

HAZE Measurements

HAZE values of the antiglare films and comparative samples obtained in the examples and comparative examples was measured according to JIS-K7105 by using a haze meter (NDH2000, manufactured by Nippon Denshoku KK). Haze values of the triacetyl cellulose film (TD-80U, manufactured by Fuji Photo Film Co., Ltd.) used for the antiglare films and the polyethylene terephthalate film (Lumirror, manufactured by Toray Industries, Inc.) used for the comparative examples were also measured.

A haze value (Hz(T)) of the antiglare layer of the antiglare film was found by subtracting the HAZE value of the triacetyl cellulose film from the HAZE value of the antiglare film. Further, the haze value (Hz(P)) of the antiglare layer of the comparative sample was found by subtracting the HAZE value of the polyethylene terephthalate film (Lumirror, manufactured by Toray Industries, Inc.) from the HAZE value of the comparative sample. The values of Hz(T), Hz(P), and haze difference (Hz(T)−Hz(P)) are shown in Table 3.

Unevenness Evaluation of Antiglare Layer

The antiglare films obtained in the examples and comparative examples were visually observed upon pasting on a transparent or black plastic plate. The results of unevenness evaluation are shown in Table 3. The visual evaluation results in which no furrows or unevenness could be confirmed are represented by a ⊚ symbol, the results in which slight furrows and unevenness were confirmed, but were at an acceptable level are represented by a ◯ symbol, and the results in which furrows and unevenness were confirmed and were at an unacceptable level are represented by a X symbol.

Evaluation of Adhesiveness

The antiglare films obtained in the examples and comparative examples were subjected to a light-induced accelerated weathering test in which they were irradiated with ultraviolet radiation for 3 h at an illumination intensity of 64 mW/cm² by using an accelerated weathering test machine (SUV-W13, manufactured by Iwasaki Electric Co., Ltd.). The adhesiveness of the antiglare layer and triacetyl cellulose film in the antiglare films subjected to the light-induced accelerated weathering test was evaluated in the following manner by a checkered tape method (according to JIS K5400).

First, an antiglare film subjected to the light-induced accelerated weathering test was fixed to a steel sheet, and notches in the form of scale marks were provided with a cutter on the antiglare layer surface to produce a checkered pattern of 10×10=100. The size of one square was 1 mm×1 mm. A cellophane pressure-sensitive adhesive tape was then pasted onto the checkered notches of the antiglare layer. The pressure-sensitive adhesive tape was then peeled off and the adhesion state of the antiglare layer and triacetyl cellulose film was verified under a microscope. The results of the adhesiveness evaluation test are shown in Table 3. The results in which the antiglare layer was not peeled off at all when the pressure-sensitive adhesive tape was peeled off were represented by a ◯ symbol, and the results in which one or more squares of the antiglare layer were peeled off were represented by a X symbol.

The HAZE values obtained for the antiglare films and comparative samples obtained in the examples and comparative examples and the unevenness evaluation results and adhesiveness evaluation results obtained for the antiglare films are shown in Table 3.

TABLE 3

| | Average | | | HAZE | | |
|---|---|---|---|---|---|---|
| | thickness of | | | difference | | |
| | antiglare layer | Hz(T) | Hz(P) | (Hz(T) − Hz(P) | Coating film | |
| | (μm) | (%) | (%) | (%) | unevenness | Adhesiveness |
| Example 1 | 5.8 | 20.2 | 18.8 | 1.4 | [symbol] | ◯ |
| Example 2 | 4.2 | 25.6 | 22.5 | 3.1 | ◯ | ◯ |
| Example 3 | 4.0 | 28.3 | 25.3 | 3.0 | ◯ | ◯ |
| Comparative | 5.0 | 21.9 | 18.4 | 3.5 | X | ◯ |
| Example 1 | | | | | | |
| Comparative | 4.3 | 28.2 | 24.9 | 3.3 | X | ◯ |
| Example 2 | | | | | | |
| Comparative | 4.8 | 19.8 | 16.3 | 3.5 | X | ◯ |
| Example 3 | | | | | | |
| Comparative | 4.1 | 29.5 | 28.9 | 0.6 | [symbol] | X |
| Example 4 | | | | | | |

What is claimed is:

1. An antiglare film comprising:
a triacetyl cellulose film; and
an antiglare layer on the triacetyl cellulose film, wherein
a haze difference (Hz(T)−Hz(P)) between a haze value (Hz(T)) of the antiglare layer and a haze value (Hz(P)) of an antiglare layer directly formed on a polyethylene terephthalate film under the same conditions as the antiglare layer formed on the triacetyl cellulose film is 1.3% or more to 3.2% or less.

2. The antiglare film according to claim 1, wherein
the antiglare layer comprising particles and a binder matrix obtained by curing a material curable with ionizing radiation that is directly provided on the triacetyl cellulose film, wherein
the antiglare layer is formed by a process of directly coating a coating liquid for forming an antiglare layer that comprises at least the particles, the material curable with ionizing radiation, and a solvent on the triacetyl cellulose film and forming a coating film on the triacetyl cellulose film, a process of drying the coating film, and a process of curing the coating film by ionizing radiation; and
a haze difference (Hz(T)−Hz(P)) between a haze value (Hz(T)) of the antiglare layer formed on the triacetyl cellulose film and a haze value (Hz(P)) of an antiglare layer directly formed on a polyethylene terephthalate film by using the coating liquid for forming an antiglare layer under the same conditions as the antiglare layer formed on the triacetyl cellulose film is 1.3% or more to 3.2% or less.

3. The antiglare film according to claim 2, wherein
a mean particle size of the particles is equal to or more than a value obtained by multiplying the average film thickness of the antiglare layer by 0.1 and equal to or less than a value obtained by multiplying the average film thickness of the antiglare layer by 1.7.

4. A transmission liquid crystal display, wherein
the antiglare film according to claim 2, a polarizing plate, a liquid crystal cell, a polarizing plate, and a backlight unit are provided in the order of description from a viewer side.

5. A coating liquid for forming an antiglare layer, comprising:
particles;
a material curable with ionizing radiation; and
a solvent, wherein
a haze difference (Hz(T)−Hz(P)) between
a haze value (Hz(T)) of an antiglare layer formed by a process of directly coating the coating liquid for forming an antiglare layer on a triacetyl cellulose film and forming a coating film on the triacetyl cellulose film, a process of drying the coating film, and a process of curing the coating film by ionizing radiation, and
a haze value (Hz(P)) of an antiglare layer directly formed on a polyethylene terephthalate film by using the coating liquid for forming an antiglare layer under the same conditions as the antiglare layer formed on the triacetyl cellulose film
is 1.3% or more to 3.2% or less.
